(19) United States
(12) Patent Application Publication
(10) Pub. No.: US 2016/0063154 A1
(43) Pub. Date: Mar. 3, 2016

(54) METHOD AND SYSTEM FOR STRUCTURED SIMULATION OF ENTERPRISE MODEL AND DATA

(71) Applicant: Tata Consultancy Services Limited, Mumbai (IN)

(72) Inventors: Suman ROYCHOUDHURY, Pune (IN); Sagar SUNKLE, Pune (IN); Hemant Kumar RATHOD, Pune (IN); Vinay KULKARNI, Pune (IN)

(21) Appl. No.: 14/839,171

(22) Filed: Aug. 28, 2015

(30) Foreign Application Priority Data
Aug. 31, 2014 (IN) 2731/MUM/2014

(51) Int. Cl. G06F 17/50

(52) U.S. Cl. CPC G06F 17/509

(57) ABSTRACT

The present disclosure discloses a method and system for structured simulation of enterprise model and data and more specifically a model-based translation approach for translating elements of Enterprise architecture (EA) and Intentional modeling (IM) to corresponding System Dynamic (SD) elements to enable simulation of enterprise data and enterprise model. The method and system may further be enabled to conduct ontology based translation. The method and system may further be enabled to perform mapping of EA elements to equivalent SD elements based on underlying EA relations. In another implementation, the method and system may be enabled to perform mapping of IM elements to equivalent SD elements based on underlying IM relations. The method and system may further be enabled to obtain feedback from the enterprise simulation to choose optimal elements from the EA and the IM like best alternative path, depending on underlying problem context or goal of the enterprise.

The present application claims priority to Indian Provisional Patent Application No. 2731/MUM/2014, filed on Aug. 31, 2014, the entirety of which is hereby incorporated by reference.

### TECHNICAL FIELD

The present disclosure described herein, relates to enterprise modeling and simulation, and more specifically, the present disclosure relates to systems and methods for simulating enterprise architecture.

### BACKGROUND

Enterprise architecture (EA) modeling is a well-defined practice for conducting an enterprise analysis, design, planning, and implementation, using a holistic approach, for successful development and execution of new strategies in an enterprise. Enterprise Architecture (EA) modeling techniques support business process reengineering of the EA by capturing existing processes and based on perceived outputs, support design of future process models capable of meeting the enterprise requirements. One of such enterprise modeling technique is System Dynamics (SD) modeling. The System Dynamics modeling tools are used extensively for policy analysis and modeling of dynamic aspects of the enterprise. The SD tools are also used for understanding behavior of complex systems of the enterprise over time. The SD tools also provide fundamental contributions to framing, understanding, and discussing complex issues and problems associated with the enterprise, however the SD tools do not provide any implication on how elements of the system should be reconfigured to yield a desired behavior.

Though the EA based models help in holistic treatment of the enterprise aspects; the EA based models are essentially static or visual in nature and cannot be typically processed by a machine. Human interpretation of such visual models of the EA is error prone and inconsistent due to varied understanding of the enterprise by each individual. Further, due to the vast nature of the models, manual analysis of the EA models is often impossible. To overcome these limitations, machine process-able simulation based techniques may be used by which human understanding of the enterprise is encoded in the form of simulation models that enables analysis of the enterprise for Business As Usual (BAU) improvement. However, manually building such simulation models from the static EA based models is time and effort consuming. Moreover, as there is no standard technique available, any manual translation mechanism is itself error prone.

### SUMMARY

Before the present systems and methods, are described, it is to be understood that this application is not limited to the particular systems, and methodologies described, as there can be multiple possible embodiments which are not expressly illustrated in the present disclosures. It is also to be understood that the terminology used in the description is for the purpose of describing the particular versions or embodiments only, and is not intended to limit the scope of the present application. This summary is provided to introduce concepts related to a method and system for structured simulation of enterprise architecture and the concepts are further described below in the detailed description. This summary is not intended to limit the scope of the disclosure.

In one embodiment, a system for generating a system dynamics model of an enterprise is illustrated. The system including a memory and a processor coupled to the memory, wherein the processor is configured to execute instructions stored in the memory for maintaining a mapping table in a repository, wherein the mapping table is configured to store a master set of enterprise architecture relations and a master set of system dynamics meta-model links, wherein each enterprise architecture relation, of the master set of enterprise architecture relations, is mapped with at least one system dynamics meta-model link of the master set of system dynamics meta-model links, and wherein each enterprise architecture relation is captured from historically analyzed enterprise meta-models. Further, the processor is configured to receive an enterprise model that conforms to an enterprise meta-model. In the next step, the processor identifies a set of enterprise architecture relations from the enterprise meta-model. Further, the processor is configured to receive a reference system dynamics meta-model, wherein the reference system dynamics meta-model corresponds to a system dynamics model to be developed for the enterprise. Furthermore, the processor compares the set of enterprise architecture relations with the master set of enterprise architecture relations based on the reference system dynamics meta-model to identify a sub-set of system dynamics meta-model links corresponding to the enterprise meta-model. Based on the sub-set of system dynamics meta-model links, the processor is configured to generate the system dynamics model.

In one embodiment, a method for generating a system dynamics model of an enterprise is illustrated. The method includes maintaining a mapping table in a repository by a processor, wherein the mapping table is configured to store a master set of enterprise architecture relations and a master set of system dynamics meta-model links, wherein each enterprise architecture relation, of the master set of enterprise architecture relations, is mapped with at least one system dynamics meta-model link of the master set of system dynamics meta-model links, and wherein each enterprise architecture relation is captured from historically analyzed enterprise meta-models. Once the mapping table is generated, in the next step, an enterprise model corresponding to an enterprise is received, wherein the enterprise model is in conformance with an enterprise meta-model of the enterprise. Further, the processor identifies a set of enterprise architecture relations from the enterprise meta-model. Further, the processor is configured to receive a reference system dynamics meta-model, wherein the reference system dynamics meta-model corresponds to a system dynamics model to be developed for the enterprise. In the next step, the processor compares the set of enterprise architecture relations with the master set of enterprise architecture relations based on the reference system dynamics meta-model to identify a sub-set of system dynamics meta-model links corresponding to the enterprise. Based on the sub-set of system dynamics meta-model links, the processor is configured to generate the system dynamics model corresponding to the enterprise.

In one embodiment, a computer program product having embodied thereon a computer program for generating a system dynamics model of an enterprise is disclosed. The computer program product includes a program code for maintaining a mapping table in a repository, wherein the mapping table is configured to store a master set of enterprise architecture relations and a master set of system dynamics meta-model links, wherein each enterprise architecture relation, of the master set of enterprise architecture relations, is mapped with at least one system dynamics meta-model link of the master set of system dynamics meta-model links, and wherein each enterprise architecture relation is captured from historically analyzed enterprise meta-models. Further, the computer program product includes a program code for receiving an enterprise model corresponding to an enterprise. Further, the computer program product includes a program code for conformance of the enterprise model with respect to an enterprise meta-model and identifying a set of enterprise architecture relations from the enterprise meta-model. Further, the computer program product includes a program code for receiving a reference system dynamics meta-model, wherein the reference system dynamics meta-model corresponds to a system dynamics model to be developed for the enterprise. Furthermore, the computer program product includes a program code for comparing the set of enterprise architecture relations with the master set of enterprise architecture relations based on the reference system dynamics meta-model to identify a sub-set of system dynamics meta-model links corresponding to the enterprise. Further, the computer program product includes a program code for generating the system dynamics model based on the set of system dynamics meta-model link.

### BRIEF DESCRIPTION OF THE DRAWINGS

The foregoing summary as well as detailed description of embodiments of the present disclosure is better understood when read in conjunction with the appended drawings. For the purpose of illustrating the disclosure, there is shown in the present document example constructions of the disclosure; however, the disclosure is not limited to the specific methods and apparatus disclosed in the document and the drawings.

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation of a system for structured simulation of an Enterprise models, in accordance with an embodiment of the present disclosure.

FIG. 2 illustrates the system, in accordance with an embodiment of the present disclosure.

FIG. 3 illustrates translation scheme for translating the Enterprise Architecture (EA) model or Intentional Modeling (IM) model to a System Dynamics (SD) model, in accordance with an embodiment of the present disclosure.

FIG. 4 illustrates a reference System Dynamics meta-model, in accordance with an embodiment of the present disclosure.

FIG. 5 illustrates the EA model of products and services of merged entity, in accordance with an embodiment of the present disclosure.

FIG. 6 illustrates an equivalent SD model of the EA model of products and services of merged entity, in accordance with an embodiment of the present disclosure.

FIG. 7 illustrates simulation graph, in accordance with an embodiment of the present disclosure.

FIG. 8 illustrates ontological representation of the IM meta-model, in accordance with an embodiment of the present disclosure.

FIG. 9 illustrates method for structured simulation, in accordance with an embodiment of the present disclosure.

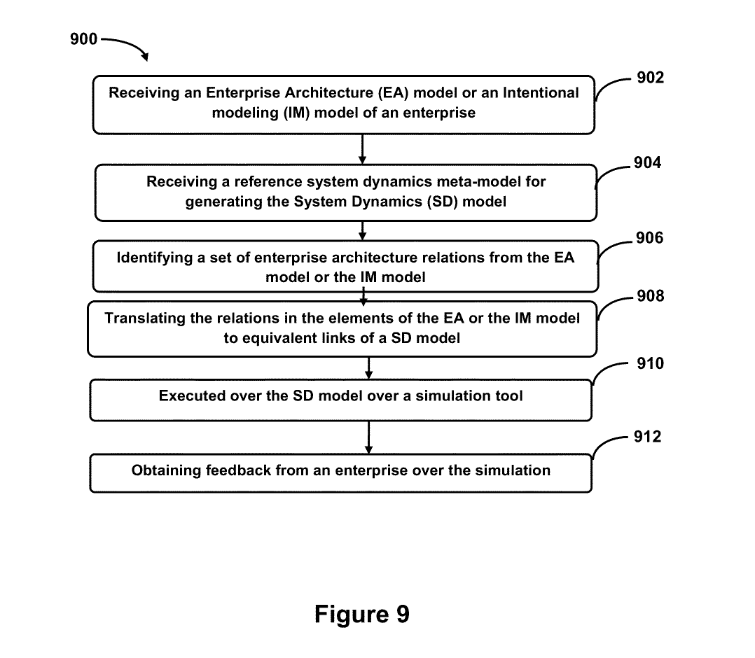

### DETAILED DESCRIPTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that the singular forms “a,” “an,” and “the” include plural references unless the context clearly dictates otherwise. Although any systems and methods similar or equivalent to those described herein can be used in the practice or testing of embodiments of the present disclosure, the exemplary, systems and methods are now described. The disclosed embodiments are merely exemplary of the disclosure, which may be embodied in various forms.

Various modifications to the embodiment will be readily apparent to those skilled in the art and the generic principles herein may be applied to other embodiments. However, one of ordinary skill in the art will readily recognize that the present disclosure is not intended to be limited to the embodiments illustrated, but is to be accorded the widest scope consistent with the principles and features described herein.

In one embodiment, the present disclosure discloses a method and system for structured simulation of enterprise model using system dynamics modeling. More specifically the method and system describes a model-based translation approach by which elements of enterprise model may be translated to corresponding System Dynamic (SD) elements to enable generation of a system dynamics model corresponding to the enterprise. The enterprise model may be an Enterprise architecture (EA) model or an Intentional modeling (IM) model. In one embodiment, a mapping table may be used for translating the EA and the IM to the SD model, wherein the mapping table is configured to store a master set of enterprise architecture relations and a master set of system dynamics meta-model links, wherein each enterprise architecture relation, of the master set of enterprise architecture relations, is mapped with at least one system dynamics meta-model link of the master set of system dynamics meta-model links, and wherein each enterprise architecture relation is captured from historically analyzed enterprise meta-models. The method and system may further be enabled to conduct ontology based translation for transforming the EA and the IM to the SD model.

In one implementation, the method and system may enable a reference system dynamics meta-model for mapping of core elements in the EA or the IM with the SD elements. Furthermore, the method and system may be enabled to perform detailed mapping of EA elements to equivalent SD elements based on underlying EA relations. In another implementation, the method and system may be enabled to perform detailed mapping of the IM elements to equivalent SD elements based on underlying IM relations. The mapping of the EA or the IM elements with the SD elements is performed using the mapping table. The method and system may further be enabled to obtain feedback from the enterprise simulation to choose optimal elements from the EM and the IM like best alternative path, depending on underlying problem context or goal of the enterprise.

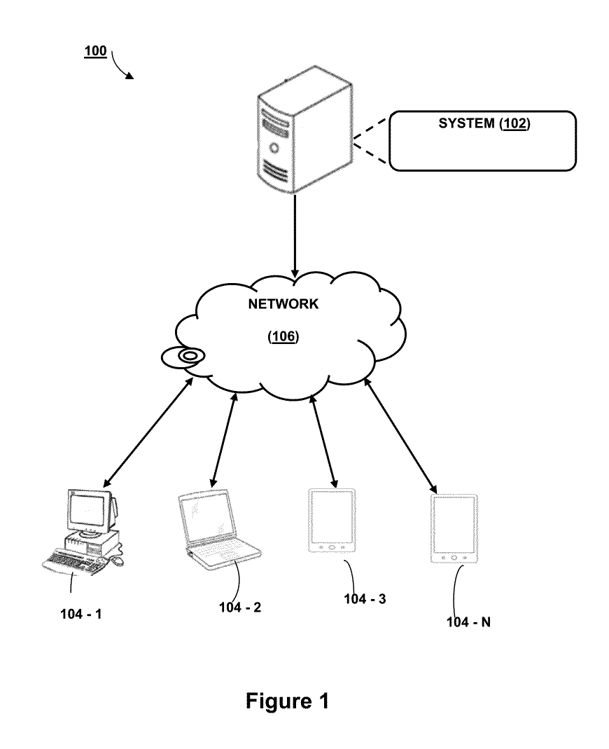

Referring now to FIG. 1, although the present subject matter is explained considering that the system 102 is implemented on a server, it may be understood that the system 102 may also be implemented in a variety of computing systems, such as a laptop computer, a desktop computer, a notebook, a workstation, a mainframe computer, a server, a network server, a cloud-based computing environment and the like. It will be understood that the system 102 may be accessed by multiple users through one or more user devices 104-1, 104-2, 104-3, 104-N, collectively referred to as user devices 104 hereinafter, or applications residing on the user devices 104. In one implementation, the system 102 may comprise the cloud-based computing environment in which a user may operate individual computing systems configured to execute remotely located applications. Examples of the user devices 104 may include, but are not limited to, a portable computer, a personal digital assistant, a handheld device, and a workstation. The user devices 104 are communicatively coupled to the system 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

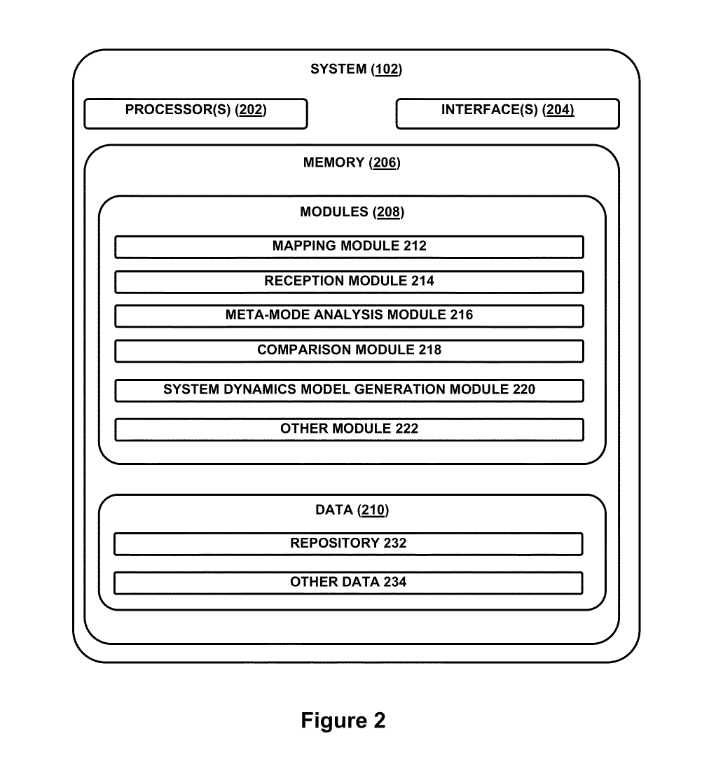

Referring now to FIG. 2, the system 102 is illustrated in accordance with an embodiment of the present disclosure. In one embodiment, the system 102 may include a processor 202, an input/output (I/O) interface 204, and a memory 206. The processor 202 may be implemented as one or more microprocessors, microcomputers, microcontrollers, digital signal processors, central processing units, state machines, logic circuitries, and/or any devices that manipulate signals based on operational instructions. Among other capabilities, the processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with the user directly or through the user devices 104. Further, the I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium and computer program product known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208, and data 210. The data 210, amongst other things, serves as a repository for storing data processed, received, and generated by execution of the modules 208.

The modules 208 include routines, programs, objects, components, data structures, etc., which perform particular tasks or implement particular abstract data types. In one implementation, the modules 208 may include a mapping module 212, a reception module 214, a meta-mode analysis module 216, a comparison module 218, a system dynamics model generation module 220, and other modules 222. The other modules 222 may include programs or coded instructions that supplement applications and functions of the system 102.

The data 210, amongst other things, serves as a database for storing data processed, received, and generated by one or more of the modules 208. The data 210 may also include a repository 232 and other data 234. The other data 234 may include data generated as a result of the execution of one or more modules in the other modules 222. Further, the repository 232 is configured to maintain, a mapping table. In one embodiment, the mapping table is generated by the mapping module 212. The mapping module 212 is configured to maintaining a mapping table in a repository 232. The mapping table is configured to store a master set of enterprise architecture relations and a master set of system dynamics meta-model links, wherein each enterprise architecture relation, of the master set of enterprise architecture relations, is mapped with at least one system dynamics meta-model link of the master set of system dynamics meta-model links. In order to generate the master set of enterprise architecture relations, a set of historically analyzed enterprise meta-models are analyzed to identify the different elements and relationship between the elements in the enterprise meta-models. These relations are then stored in the form of the master set of enterprise architecture relations. Further, the mapping module is configured to identify at least one system dynamics meta-model link corresponding to each enterprise architecture relation.

In one embodiment, once the mapping table is generated, in the next step, an enterprise model corresponding to an enterprise is accepted by the reception module 214. In one embodiment, the enterprise model can be a Enterprise Architecture (EA) model or an Intentional Modeling (IM) model. The reception module 214 is configured to convert the enterprise model into an enterprise meta-model. Further, the meta-mode analysis module 216 is configured to identify a set of enterprise architecture relations from the enterprise meta-model. In one example if the enterprise model is in the form of an Enterprise Architecture (EA) model conforming to ArchiMate, then the EA model and EA meta-model are analyzed to identify different elements in the EA meta-model such as active structure entities (ASEs), behavior entities (BEs), and passive structure entities (PSEs). Further, in case of an Intentional Modeling (IM) model, the IM model is analyzed to determine whether the Intentional model is in conformity with an IM meta-model of the enterprise and accordingly, the IM meta-model is analyzed to identify elements such as actors, tasks, resources, (soft) goals and the like are identified. The enterprise meta-model is further analyzed to identify relations between elements using standard model analysis tools by the meta-mode analysis module 216 and capture the set of set of enterprise architecture relations.

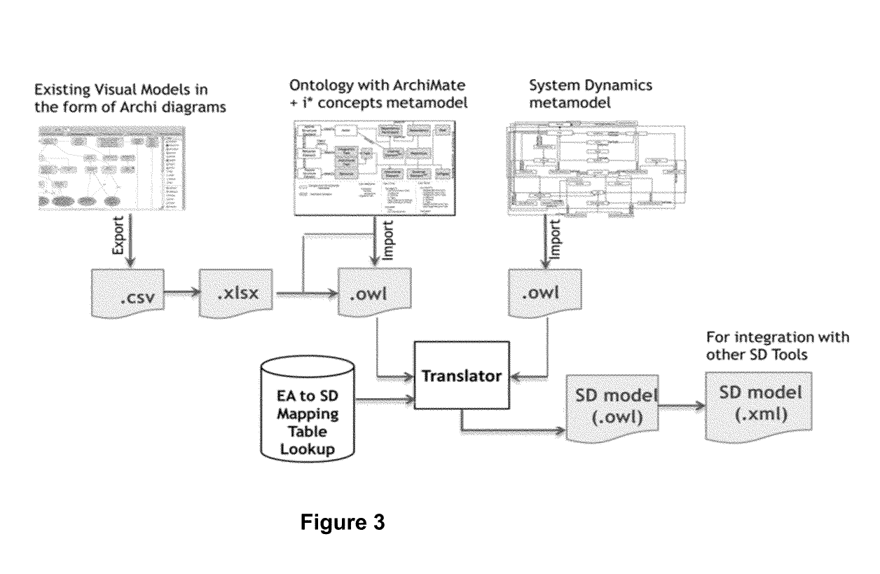

In the next step, the reception module 214 is configured to receive a reference system dynamics meta-model. The reference system dynamics meta-model corresponds to a system dynamics model to be developed for the enterprise. The reference system dynamics meta-model corresponds stores links between different elements in between the system dynamics model to be developed. Once the reference system dynamics meta-model is accepted, in the next step, the comparison module is configured to compare the set of enterprise architecture relations with the master set of enterprise architecture relations based on the reference system dynamics meta-model to identify a sub-set of system dynamics meta-model links corresponding to the enterprise. Based in the identified sub-set of system dynamics meta-model links, the system dynamics model generation module 220 is configured to generate the system dynamics (SD) model. In an embodiment, steps performed for translating the EA models into the SD models are now explained referring to FIG. 3.

As illustrated in the FIG. 3, the translation of the EA model to the SD model may comprise of exporting .csv files containing the Enterprise Architecture (EA) model of the enterprise in the form of Archi by the reception module 214. The .csv files may then be converted into .xlsx file format for easy integration with .owl based tool editors like Protégé® by the reception module 214. Further, the reference system dynamics (SD) meta-model and ontological representation may then be imported in .owl format by the reception module 214. In next step, using mapping table (as represented in Table 1 and Table 2 below), the comparison module 218 be enabled to adapt appropriate search strategy to convert each relation between element of the EA model to corresponding SD links form for generating the SD model by the system dynamics model generation module 220 and thereafter the SD models may be translated into .owl format. For sake of easy integration with other SD tools like iThink®, Simantics®, the translated SD models in .owl file format are converted to .xml format by the system dynamics model generation module 220. To enable simulation of the EA models, the method and system may utilize ontological representation of EA concepts.

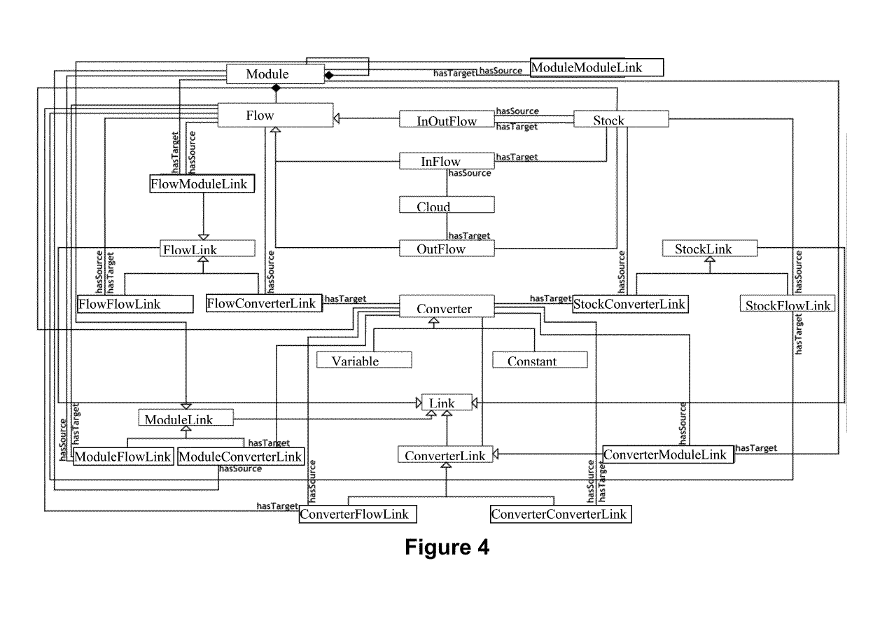

In one embodiment, the translation may further depend upon mapping of elements of EA meta-model with the SD meta-model which may be carried out using the reference meta-model prepared for the SD model, and an ontological representation of the EA model. The metamodel of the SD may further be explained in FIG. 4.

Referring to the FIG. 4, in the reference meta-model of the SD model to be generated for the enterprise is disclosed. In one embodiment a module in the SD model may represent an independent compositional or aggregate unit that captures part behavior of a system associated with the SD built for simulating dynamic behavior of the EA model in a modular way and consists of primitive entities like stocks, flow and converters along with relationships amongst themselves. Data may be exchanged between the modules and with primitive entities like stocks, flow, and variables via suitable links. The primitive entities may further be explained in detail in following description.

The stock may represent a central entity that may change or transform with passage of time as determined by inflow and outflow from the stock. The flow may control the behavior of the stock and the flow is the only way to control or alter magnitude of the stock. The flow may be of three types namely, inflow, outflow, and in-out flow. The inflow is a flow that has target as the stock and source as cloud, wherein the cloud represents beginning or end of the flow, whereas the outflow represents a flow that has the target as the cloud and source as the stock. Similarly the in-out flow has both the source and the target as the stock. In addition to the stocks, the flows may also influence other flows or the converters via flow-flow links or flow-converter links. Furthermore, the converters may influence the variables that control the inflow, the outflow or other converters and in general the dynamic behavior of the EA model. However, the converter may not directly influence the behavior of the stocks; the converter may only do so indirectly via the flow. The converters might be either the variables or constants. Links or connectors may form key model elements that connect or establish linkages among other primitive elements like the stocks, the flows, the converters and the module as shown in the FIG. 4.

Additionally, the FIG. 4 illustrates the translation of the ArchiMate based EA model by mapping the EA elements namely active structure entities (ASEs), behavior entities (BEs), and passive structure entities (PSEs) with the equivalent SD elements. As such, the BEs in the EA models may be mapped to either the flows or the converters based on different contexts associated with the EA element. The BE may further be mapped to the flow if the BE is connected with the stock; otherwise the BE may be mapped to the converter. Resources in the EA are either documents or the data that may be accessed for writing and reading, or the resources may be human or non-human resources which may be produced and consumed. As such, the PSEs in the EA models may be mapped to the stocks based on the EA element contexts. Finally, the ASEs in the EA models namely, human actor including roles, departments and applications may be assigned to the BEs in terms of being responsible for specific BEs. Also the ASEs may be translated to the modules which may act as containers for elements for which given ASEs are responsible for.

Furthermore, there might be four different kinds of links namely a FlowLink, StockLink, ModuleLink and ConverterLink that may be derived from base concept Link. Each link type may further be categorized based on the source and the target model element. For example, the link that connects the converter with another converter may be called a converter-converter link. The link that connects the converter to the flow and vice versa may be called a converter-flow link and a flow-converter link respectively. Similarly, the link that may have its source element as the stock and the target element as either a low or the converter may be called a stock-flow or a stock-converter link. The metamodel of the SD as shown in the FIG. 4 represents various types of links. The translation of the EA models to the SD models by mapping of the EA elements with the equivalent SD elements may further be explained using table 1.

Table 1 below illustrates the mapping of the relation between elements of the EA to the equivalent SD meta-model links, based on the reference SD meta-model links created as shown in the FIG. 4.

TABLE 1

| | | | SD Metamodel Specifics |
|---|---|---|---|
| Entry | EA Relation | How the EA Entities Relate | Links |
| 1 | BE to ASE | ASE is responsible for/assigned | A ModuleFlow link connects |
| | | to the BE, furthermore, the BE | a module entity with a flow |
| | | accesses/uses a PSE. | |
| 2 | BE to ASE | ASE is responsible for/assigned | A ModuleConverter link |
| | | to the BE, furthermore, the BE | connects a module entity with |
| | | does not access/use a PSE. | a converter |
| 3 | BE to ASE | BE is exposed to the ASE, BE | A FlowModule link and a |
| | | may or may not be | ConverterModule link |
| | | accessing/using a PSE directly | connect flows and/or |
| | | | converters to Module entities |
| 4 | BE to BE | A BE triggers/Flows To another | A FlowFlow link connects two |
| | | BE, both are accessing/using a | Flows |
| | | PSE | |
| 5 | BE to BE | A BE triggers/Flows To another | A ConverterConverter link |
| | | BE, both are NOT | connects two converters |
| | | accessing/using a PSE | |
| 6 | BE to BE | A BE not accessing/using a PSE | A ConverterFlow link |
| | | triggers/Flows To another BE | connects a converter to a flow |
| | | which is accessing/using a PSE | |
| 7 | BE to BE | A BE is accessing/using a PSE | A FlowConverter link |
| | | and triggers/Flows To another BE | connects a flow to a converter |
| | | which is NOT accessing/using a | |
| | | PSE | |
| 8 | BE to PSE | BE is writing/deploying to the | An inflow writes to a stock. |
| | | PSE | This increases the volume or |
| | | | magnitude of the stock |
| 9 | BE to PSE | BE is consuming the PSE | An outflow consumes a stock. |
| | | | This decreases the volume or |
| | | | magnitude of the stock |
| 10 | BE to PSE | BE is reading the PSE and BE is | A StockFlow link connects a |
| | | accessing/using some other PSE | stock to a flow |
| | | as well | |
| 11 | BE to PSE | BE is reading the PSE and BE is | A StockConverter link |
| | | not accessing/using any other | connects a stock to a converter |
| | | PSE as well | |
| 12 | ASE | Two or more ASEs are part of | A ModuleModule link |
| | Collaboration | Collaboration and involved in | connects a module to another |
| | | Interaction | module to collaborate their |
| | | | functionalities |
| 13 | Attributes of | Attributes of any EA entity | Either a ConverterConverter |
| | EA to BE | [BE/ASE/PSE] are made | link or a ConverterFlow link |
| | | available to BE entity. | connects a converter to BE |
| | | | entity |

Table 1 shows variety of the enterprise architecture relations between elements of the EA model and the corresponding link types in the SD metamodel that may be used to represent the SD equivalent of the EA element contexts. Referring to the table 1, entries 1 to 11 capture all possible variations of relations between the BEs, the ASEs, and the PSEs. For example, entry 1 shows that if the BE is assigned to the PSE and furthermore the BE is assigned accesses or uses the PSE, then a ModuleFlow link may be used to represent the context in the mapping.

In an embodiment, table 2 shows a visual representation of the SD links of each relation between elements of the EA model, as shown in the Table 1, along with the semantic interpretation.

TABLE 2

| | EA | System Dynamics | |
|---|---|---|---|
| Entry | Relation | Representation | Semantic Interpretation |
| 1 | 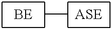 | 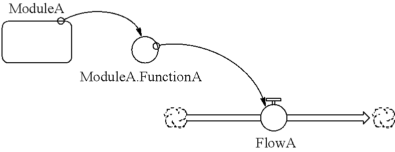 | ModuleA.FunctionA can be used as a parameter in function definition at FlowA |
| 2 | 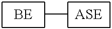 | 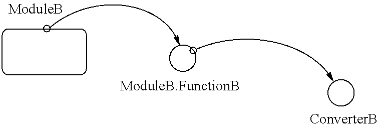 | ModuleB.FunctionB can be used as a parameter in function definition at ConverterB |
| 3 | 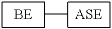 | 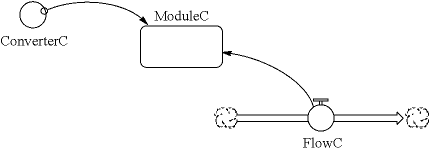 | ConvertC and FlowC can be used as parameters in function definition for any entity of ModuleC |
| 4 | 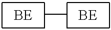 | 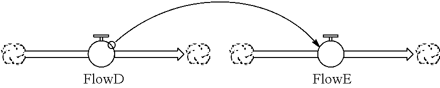 | FlowD can be used as a parameter in function definition at FlowE |
| 5 | 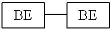 | 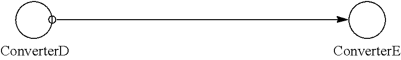 | ConverterD can be used as a parameter in function definition at ConverterE |
| 6 | 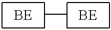 | 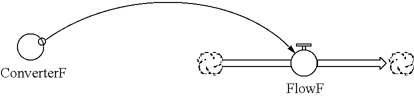 | ConverterF can be used as a parameter in function definition at FlowF |
| 7 | 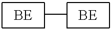 | 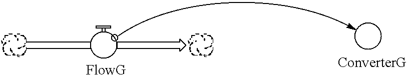 | FlowG can be used as a parameter in function definition at ConverterG |
| 8 | 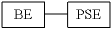 | 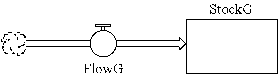 | StockG quantity increases with time quanta based on FlowG value |
| 9 | 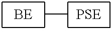 | 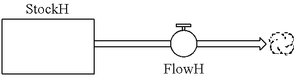 | StockH quantity decreases with time quanta based on FlowH value |
| 10 | 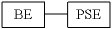 | 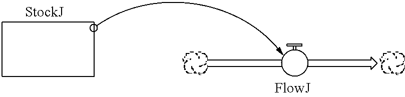 | StockJ can be used as a parameter in function definition at FlowJ |
| 11 | 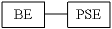 | 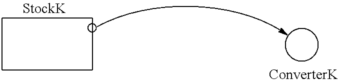 | StockK can be used as a parameter in function definition at ConverterK |
| 12 | 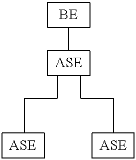 | 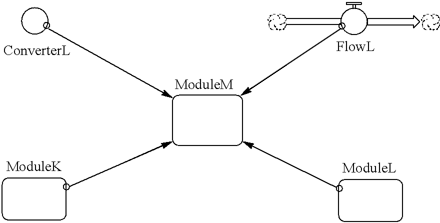 | Entities of ModuleK and ModuleL can be used as parameters in function definitions of entities in ModuleM |
| 13 | 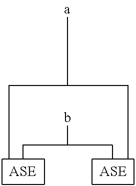 | 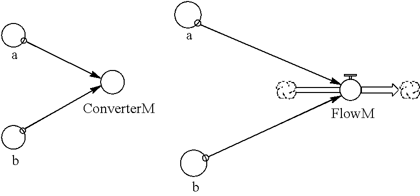 | Attributes a and b can be used as parameters in function definitions in ConverterM or FlowM [a and b are specified in underlying ontological representation] |

The table 2 further illustrates which arguments may become available for expressing behavior in the SD representation resulting from different EA element relations. Together, the tables 1 and 2 represent various ways in which the relation between different EA elements may be translated to equivalent SD links.

Furthermore, functionality may be provided to specify which elements in the EA model need to be considered for translation to the SD model and which should not be, by a first set of tags in the ontological representation. Therefore, this first set of tags restricts the scope of the EA model. Further a second set of tags may be used to specify which equation or the function needs to be made available to the translator so that the equation or the function may be included at a specific SD element. Therefore, the second set of tags enriches the functionality of the SD model. The tags may essentially be object properties and the data properties of the elements in the ontological representation.

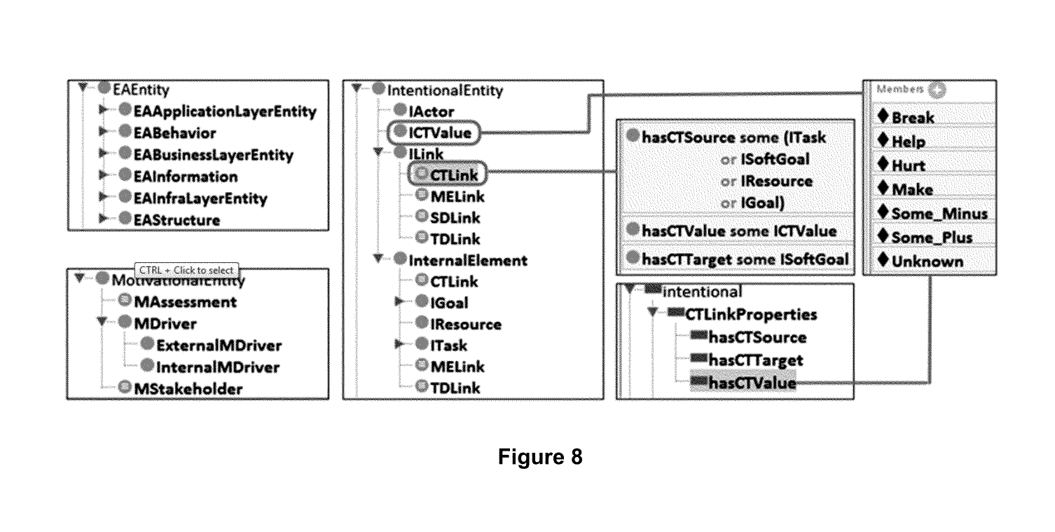

In an embodiment, the translation of an Intentional Model (IM) to the SD model may be explained referring tables 3 and 4. Further, an intentional meta-model of the IM may distinguish between elements internal to an actor and external to the actor. The relations in the IM namely, means-end (MELink), task decomposition (TDLink), contribution (CTLink), and strategic dependency (SDLink) relations, as reified relations in the ontology representation may be explained through the table 3. For an example, a contribution link (CTLink) may indicate not only which element contributes (hasCTSource) to a soft goal but also what that contribution is (ICTValue) as shown in FIG. 8.

TABLE 3

| | Intentional | How Intentional entities are | |
|---|---|---|---|
| ENTRY | Relation | related | Metamodel Specifics Links |
| \textcircled{1} | MELink | Goal Decomposed into Intentional | An inflow writes to a stock. |
| | | Task | This increases the volume or |
| | | | magnitude of the stock |
| \textcircled{2} | MELink | Goal Decomposed into Integration | An inflow writes to a stock. |
| | | Task | This increases the volume or |
| | | | magnitude of the stock |
| \textcircled{3} | TDLink | Intentional Task decomposed into | A FlowFlow link connects |
| | | Intentional Task, both tasks are | two Flows |
| | | connected to goals | |
| \textcircled{4} | TDLink | Intentional Task decomposed into | A ConverterFlow link |
| | | Intentional Task, the target task is | connects a converter to a flow |
| | | connected to a goal | |
| \textcircled{5} | TDLink | Intentional Task decomposed into | A ConverterConverter link |
| | | Intentional Task, none of the tasks | connects two converters |
| | | are connected to goals | |
| \textcircled{6} | TDLink | Intentional Task decomposed into | A FlowConverter link |
| | | Intentional Task, the source task is | connects a flow to a converter |
| | | connected to goal | |
| \textcircled{7} | TDLink | Intentional Task decomposed into | A ConverterFlow link |
| | | Integration Task; the integration | connects a converter to a flow |
| | | task always contributes to a soft | |
| | | goal and is therefore represented as | |
| | | a flow (cf. no. 11 below) | |
| \textcircled{8} | TDLink | Intentional Task decomposed into | A FlowFlow link connects |
| | | Integration Task; the source | two Flows |
| | | intentional task is itself connected | |
| | | to a goal | |
| \textcircled{9} | TDLink | Task decomposed into Hard Goal | A StockFlow link connects a |
| | | | stock to a flow |
| \textcircled{10} | SDLink | Task decomposed to Soft Goal | A ModuleConverter link |
| | | | connects entity of one module |
| | | | with entity of another module |
| \textcircled{11} | SDLink | Integration Task contributes to Soft | A ModuleConverter link |
| | | | connects entity of one module |
| | | Goal | with entity of another module |
| \textcircled{12} | Attributes | Attributes of any Intentional entity | Either a ConverterConverter |
| | of any | are made available to Intentional or | link or a ConverterFlow link |
| | Intentional | Integration Task. | connects a converter to BE |
| | Entity to | | entity |
| | Intentional/ | | |
| | Integration | | |
| | Task | | |

TABLE 4

| | Intentional | System Dynamics | |
|---|---|---|---|
| Entry | Relation | Representation | Semantic Interpretation |
| 1 | MELink | 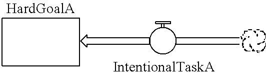 | HardGoalA quantity increases (satisfaction level rises) with time quanta based on IntentionalTaskA value. If HardGoalA is a root goal rather than intermediate goal, then simulation can be halted when HardGoalA reaches a pre-determined value. |
| 2 | MELink | 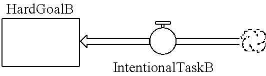 | HardGoalB quantity increases (satisfaction level rises) with time quanta based on IntentionalTaskB value. If HardGoalB is a root goal rather than intermediate goal, then simulation can be halted when HardGoalB reaches a pre-determined value. |
| 3 | TDLink | 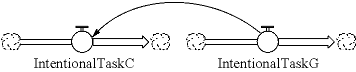 | IntentionalTaskC can be used as a parameter in function definition at IntentionalTaskG. |
| 4 | TDLink | 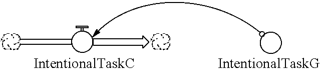 | IntentionalTaskG can be used as a parameter in function definition at IntentionalTaskC. |
| 5 | TDLink | 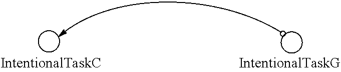 | IntentionalTaskG can be used as a parameter in function definition at IntentionalTaskC. |
| 6 | TDLink | 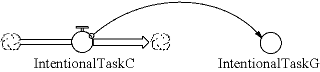 | IntentionalTaskC can be used as a parameter in function definition at IntentionalTaskG |
| 7 | TDLink | 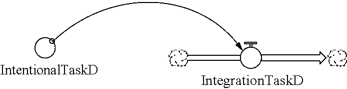 | IntentionalTaskD can be used as a parameter in function definition at IntegrationTaskD. |
| 8 | TDLink | 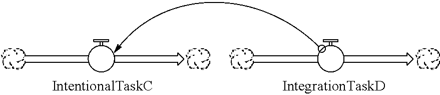 | IntegrationTaskD can be used as a parameter in function definition at IntentionalTaskC. |
| 9 | TDLink | 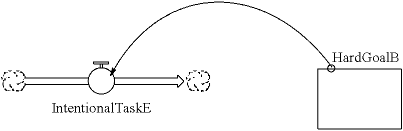 | HardGoalB can be used as a parameter in function definition at IntentionalTaskE |
| 10 | SDLink | 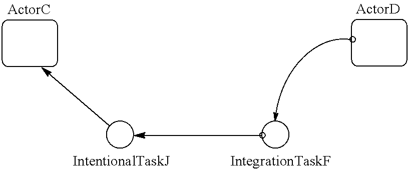 | IntegrationTaskF in ActorD is available as parameter in function definition at IntentionalTaskJ in ActorC. |
| 11 | SDLink | 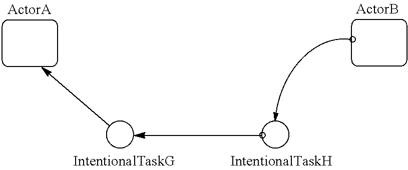 | IntentionalTaskH in ActorB is available as parameter in function definition at IntentionalTaskG in Actor A. |
| 12 | Attributes of any Intentional Entity to Intentional/ Integration Task | 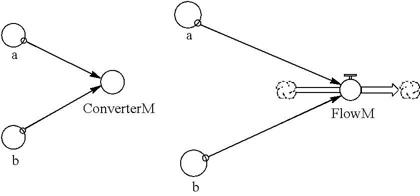 | Attributes a and b can be used as parameters in function definitions in ConverterM or FlowM [a and b are specified in underlying ontological representation] |

While other aspects of the present subject matter, the system and method for the analysis of enterprise using model-based approach may be implemented in any number of different computing systems, environments, and/or configurations, the embodiments may be described in the context of the following exemplary system.

According to the exemplary embodiment, a merger and acquisition (M&A) of two wealth management WM1 and WM2 banks is considered. Presuming that the M&A has already taken place, the merged entity (WM3), an outcome of the M&A of the WM1 and WM2, ponders over how to rationalize products and services portfolio that now contains many similar products as a result of the M&A. The mapping table as represented in the Tables 1 and 2 are used to obtain the corresponding SD model over which simulation may be run. The new product mix arising out of the M&A, WM1 products and WM2 products, may need to be optimized for better sales opportunities i.e. revenue growth and better profitability such as the M&A goal of tripling profit margins over a period of 5 years.

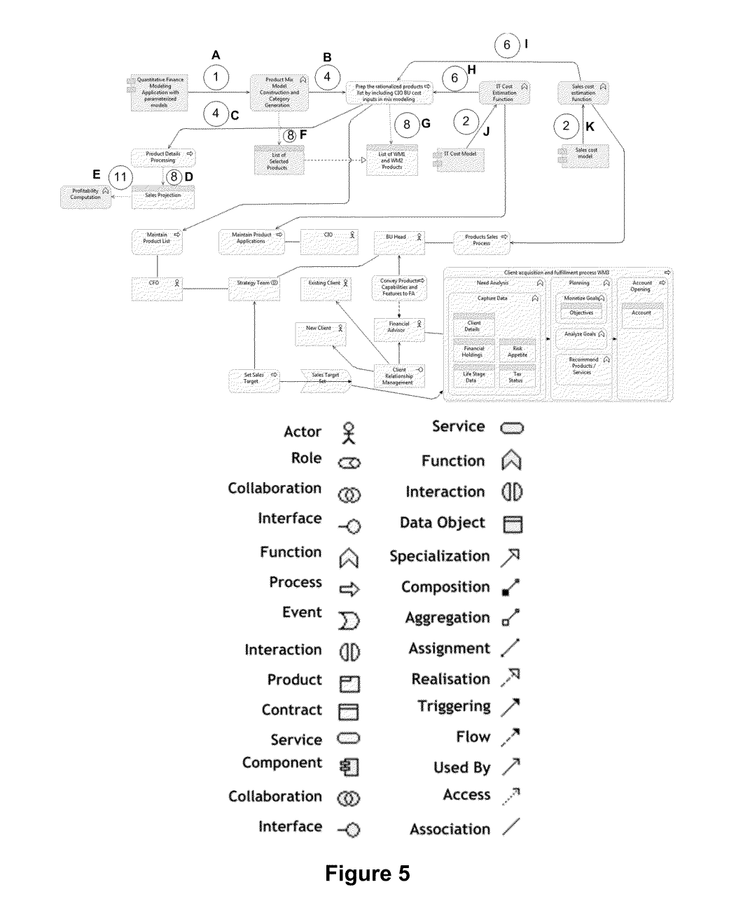

Now referring to FIG. 5, illustrates the EA model of the products and the services of the merged entity i.e. the WM3. A scenario described in the exemplary embodiment demands that a Chief Financial Officer (CFO) or Research Head (RH) determine Contribution Margins (CM) of each of the products associates with the WM3. Further the CFO or the RH may compare the CMs of similar products in similar product line associated with domains such as Retirement Products, Banking or Lending Products, and Equities Products and the like. The EA model with the entities relevant to the M&A is shown in the FIG. 5.

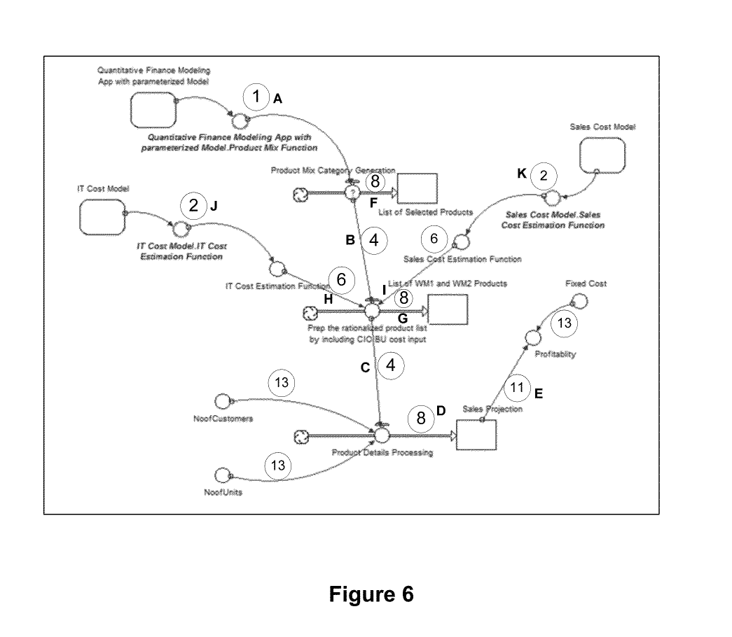

For a given set of products within the product line, value of the CM of a particular product may be used to compare with other competitive products within same market segment to take decisions such as whether to continue with the same product because of higher CM, or enhance the product to reduce the variable costs associated with the product, and/or increase price because of better demand, or decommission the product altogether because of negative or relatively less CM. In order to simulate the future market conditions/scenarios with respect to products mix rationalization context, it may be essential to consider demand from wealth management client perspective. Two kinds of variable costs, which are of importance, were considered for the simulation in the present exemplary embodiment; namely sales cost and IT or Operations cost. The Chief Information Officer's (CIO) or Chief Operation Officer's (COO) inputs may be considered to incorporate on-ground inputs on the IT or Operations cost component of the variable cost. Similarly, the inputs of BU Heads may also be considered for the revenue/price/demand i.e. sales potential per month in terms of number of units sold to number of customers, components along with the sales cost component. Based on the above, set of enterprise architecture relations present in the EA meta-model are identified. This set of enterprise architecture relations is compared with the master set of enterprise architecture relations in order to identify the sub-set of system dynamics meta-model links corresponding to the enterprise. Further, the SD model may be prepared based on the sub-set of system dynamics meta-model links corresponding to the enterprise as shown in the FIG. 5. Corresponding SD model equivalent to the EA model may be generated as disclosed in FIG. 6.

FIG. 6 illustrates the equivalent SD elements for the EA model according to the exemplary embodiment. The FIGS. 5 and 6 show the elements relevant for simulation which are translated leaving aside the rest of the EA model. The circled numbers in the FIG. 6 may refer to corresponding entries in the tables 1 and 2. The FIG. 6 illustrates an example wherein the EA element context between Application-Component Quantitative Finance Modeling Application with Parameterized Models and Application Function Product Mix Model and Category Generation Function is translated using 1 in the tables 1 and 2. The bold letter ‘A’ in FIG. 5 matches with corresponding ‘A’ in the FIG. 6 to indicate where in the SD model equivalent of given EA element context is.

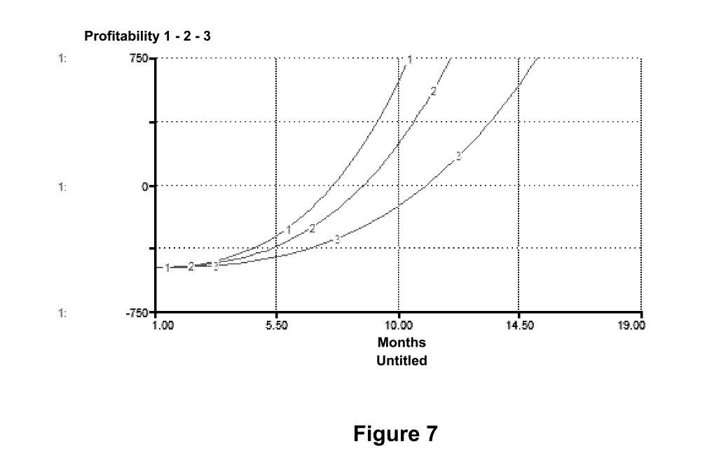

Furthermore, FIG. 7 shows a graph of three different scenarios namely 1, 2 and 3 as shown in the graph by three separate lines. The line 1 in the graph represents product mix model incorporating both IT and sales cost. The line 2 represents product mix model incorporating only the IT costs, and finally, the line 3 in the graph represents product mix model considering only general parameters without incorporating the IT and the sales cost. As the simulation model is played around with, in terms of values of different parameters, the configuration for the optimum scenario may be utilized in reality with modifications to the original values in the EA model. Hence the SD model is first built as conformant to the SD metamodel as shown in the FIG. 4 and from there, needs to be further translated to specific tooling format that will be used for actual simulation.

According to the present subject matter the steps in which the method 900 is described is not intended to be construed as a limitation, and any number of the described method blocks can be combined in any order to implement the method 900 or alternate methods. Additionally, individual blocks may be deleted from the method 900 without departing from the spirit and scope of the disclosure described herein. Furthermore, the method can be implemented in any suitable hardware, software, firmware, or combination thereof. However, for ease of explanation, in the embodiments described below, the method 900 may be considered to be implemented in the above described in the system 102.

At block 902, an Enterprise Architecture (EA) model of an enterprise may be received in the form of Archi in .csv format by the reception module 214. After receiving the EA model, the .csv files are converted into .xlsx file format by the for easy integration with .owl based tool editors like Protéǵe®. In one embodiment the ontological representation of the IM model corresponding to the enterprise may be imported. The ArchiMate® and the i*(Intentional) meta-model in form of ontology of the IM is imported in .owl format using tools like the Protégé editor, Jena OWL® ontology API, Pellet Reasoner API, and SPARQL query language for further processing by the reception module 214.

At block 904, a reference system dynamics meta-model is received by the reception module 214. The reference system dynamics meta-model and the ontological representation of the EA model or IM model may then be imported in .owl format.

At block 906, a set of enterprise architecture relations is identified from the EA meta-model or the IM meta-model.

At block 908, using the mapping table generated by the mapping module 212, the comparison module 218 may implement appropriate search strategy to convert the set of enterprise architecture relations to corresponding sub-set of SD links and thereafter the sub-set of SD links may used to generate the SD model. The SD model may be translated into .owl format by the system dynamics model generation module 220. For easy integration with other SD tools like iThink®, Simantics®, the translated SD models in .owl file format may be converted to .xml format by the system dynamics model generation module 220.

At block 910, simulation of the SD model generated by the system dynamics model generation module 220 may be executed over a simulation tool.

At block 912, feedback from the end user may be obtained over the simulation of the SD to choose optimal elements from the EA or the IM elements such as best alternative path, depending on underlying problem context/goal of the enterprise.

Although implementations for method(s) and system(s) for structured simulation of enterprise data have been described in language specific to structural features and/or methods, it is to be understood that the implementations and/or embodiments are not necessarily limited to the specific features or methods described. Rather, the specific features and methods are disclosed as examples of implementations for the structured simulation of the enterprise data.

Exemplary embodiments discussed above may provide certain advantages. Though not required to practice aspects of the disclosure, these advantages may include those provided by the following features.

Some embodiments enable a system and a method allows mapping that uses existing EA models and Intentional models (IM) to generate corresponding SD models, thus one need not create the elements of the SD model from scratch.

Some embodiments enable a system and a method that allows comprehensive SD metamodel that may be used for translating other or newer enterprise modeling concepts to the SD that may provide execution semantics.

1. A system for generating a system dynamics model of an enterprise, the system comprising:
a memory; and
a processor coupled to the memory, wherein the processor is configured to execute instructions stored in the memory for:
maintaining a mapping table in a repository, wherein the mapping table is configured to store a master set of enterprise architecture relations and a master set of system dynamics meta-model links, wherein each enterprise architecture relation, of the master set of enterprise architecture relations, is mapped with at least one system dynamics meta-model link of the master set of system dynamics meta-model links, and wherein each enterprise architecture relation is captured from historically analyzed enterprise meta-models;
receiving an enterprise model corresponding to an enterprise;
conforming that the enterprise model corresponds to an enterprise meta-model;
identifying a set of enterprise architecture relations from the enterprise meta-model;
receiving a reference system dynamics meta-model, wherein the reference system dynamics meta-model corresponds to a system dynamics model to be developed for the enterprise;
comparing the set of enterprise architecture relations with the master set of enterprise architecture relations based on the reference system dynamics meta-model to identify a sub-set of system dynamics meta-model links corresponding to the enterprise; and
generating the system dynamics model based on the set of system dynamics meta-model link.

2. The system of claim 1, wherein the enterprise model corresponding to the enterprise is selected from an enterprise architecture model or an intentional model.

3. The system of claim 1, wherein the reference system dynamics meta-model is configured to enable mapping of core elements in the enterprise model with the elements in system dynamics model.

4. The system of claim 1, further configured to simulate the system dynamics model using a simulation tool.

5. The system of claim 4, wherein a feedback obtained from the simulation tool is used for refining the enterprise model.

6. A method for generating a system dynamics model of an enterprise, the method comprising:
maintaining, by a processor, a mapping table in a repository, wherein the mapping table is configured to store a master set of enterprise architecture relations and a master set of system dynamics meta-model links, wherein each enterprise architecture relation, of the master set of enterprise architecture relations, is mapped with at least one system dynamics meta-model link of the master set of system dynamics meta-model links, and wherein each enterprise architecture relation is captured from historically analyzed enterprise meta-models;
receiving, by the processor, an enterprise model corresponding to an enterprise;
conforming that the enterprise model corresponds to an enterprise meta-model;
identifying, by the processor, a set of enterprise architecture relations from the enterprise meta-model;
receiving, by the processor, a reference system dynamics meta-model, wherein the reference system dynamics meta-model corresponds to a system dynamics model to be developed for the enterprise;
comparing, by the processor, the set of enterprise architecture relations with the master set of enterprise architecture relations based on the reference system dynamics meta-model to identify a sub-set of system dynamics meta-model links corresponding to the enterprise; and
generating, by the processor, the system dynamics model based on the set of system dynamics meta-model link.

7. The method of claim 6, wherein the enterprise model corresponding to the enterprise is selected from an enterprise architecture model or an intentional model.

8. The method of claim 6, wherein the reference system dynamics meta-model is configured to enable mapping of core elements in the enterprise model with the elements in system dynamics model.

9. The method of claim 6, further configured to simulate the system dynamics model using a simulation tool.

10. The method of claim 4, wherein a feedback obtained from the simulation tool is used for refining the enterprise model.

11. A computer program product having embodied thereon a computer program for generating a system dynamics model of an enterprise, the computer program product comprising:
a program code for maintaining a mapping table in a repository, wherein the mapping table is configured to store a master set of enterprise architecture relations and a master set of system dynamics meta-model links, wherein each enterprise architecture relation, of the master set of enterprise architecture relations, is mapped with at least one system dynamics meta-model link of the master set of system dynamics meta-model links, and wherein each enterprise architecture relation is captured from historically analyzed enterprise meta-models;
a program code for receiving an enterprise model corresponding to an enterprise;
a program code for conformance of the enterprise model with respect to an enterprise meta-model;
a program code for identifying a set of enterprise architecture relations from the enterprise meta-model;
a program code for receiving a reference system dynamics meta-model, wherein the reference system dynamics meta-model corresponds to a system dynamics model to be developed for the enterprise;
a program code for comparing the set of enterprise architecture relations with the master set of enterprise architecture relations based on the reference system dynamics meta-model to identify a sub-set of system dynamics meta-model links corresponding to the enterprise; and
a program code for generating the system dynamics model based on the set of system dynamics meta-model link.
